(19) United States
(12) Patent Application Publication
(10) Pub. No.: US 2023/0134341 A1
(43) Pub. Date: May 4, 2023

(54) Hot-Melt Formulations Utilizing Depolymerized Polymeric Material

(71) Applicant: GreenMantra Recycling Technologies Ltd., Brantford (CA)

(72) Inventors: Domenic Di Mondo, Brampton (CA); Irina Fenton, Burlington (CA)

(21) Appl. No.: 18/091,345

(22) Filed: Dec. 29, 2022

Related U.S. Application Data
(63) Continuation of application No. 17/006,903, filed on Aug. 31, 2020, now abandoned.
Application No. 17/006,903 is a continuation of application No. PCT/CA2019/000046, filed on Apr. 12, 2019.

(51) Int. Cl. C08L 23/12; C08L 23/06; C08L 25/08; C08L 31/04; C08L 93/04; C09J 11/08

(52) U.S. Cl. CPC C08L 23/12; C08L 23/06; C08L 25/08; C08L 31/04; C08L 93/04; C09J 11/08; C08L 2205/035

(57) ABSTRACT

A hot-melt formulation can utilize a depolymerized polymeric material such as a wax, styrenic polymer, and/or styrenic oligomer, wherein the wax, styrenic polymer, and/or styrenic oligomer is created via depolymerization of a polymer. In some embodiments, the polymer is polypropylene. In some embodiments, the polymer is polyethylene. In some embodiments, the polymer is polystyrene. In some embodiments, the hot-melt formulation can include, among other things, ethylene-vinyl acetate copolymers, olefinic block copolymer, amorphous polyolefins, styrene block copolymers, amorphous poly-alpha-olefins, thermoplastic polyolefins, tackifiers, stabilizers, paraffin waxes and/or Fisher Tropsch waxes.

### CROSS-REFERENCE TO RELATED APPLICATION

This application is a continuation of and claims priority benefits from U.S. patent application Ser. No. 17/006,903 filed on Aug. 31, 2020, entitled “Hot-Melt Formulations Utilizing Depolymerized Polymeric Material”. The '903 application is a continuation of and claims priority benefits from International application No. PCT/CA2019/000046 filed on Apr. 12, 2019, also entitled, “Hot-Melt Formulations Utilizing Depolymerized Polymeric Material” which, in turn claims priority benefits from U.S. provisional patent application Ser. No. 62/656,730 filed on Apr. 12, 2018, entitled “Hot-Melt Formulations Utilizing Polypropylene Waxes”. This application also claims priority benefits from the '046 and '730 applications. The '903, '046 and '730 applications are each hereby incorporated by reference herein in their entireties.

### FIELD OF THE INVENTION

The present invention relates to methods of creating hot-melt formulations employing polymeric material as an additive. The polymeric material can be in the form of polyethylene waxes, polypropylene waxes, styrenic polymers and/or styrenic oligomers. In some embodiments, the waxes, styrenic polymers and/or styrenic oligomers are made, at least in part, from recycled plastic materials.

Hot-melt formulations can include, but are not limited to, hot-melt adhesives, sealants, and coatings. These hot-melt formulations are used, among other places, in the packaging, furniture, textile, automotive, footwear and road construction industries. In many embodiments, hot-melt adhesive formulations are sold as solid bricks, rods, and/or granules that can be melted and applied to various substrates during the manufacturing process.

Hot-melt adhesive formulations often do not require volatile solvents, allow for storage at room temperature, have fast cure times, excellent shelf-lives, and offer a wide variety of grades and technical attributes, with good chemical and thermal stability.

Hot-melt adhesive formulations can be comprised of, among other things, scaffold polymers (such as, but not limited to, polyester(s), olefinic block copolymer(s), amorphous polyolefins, polyacrylates, polyurethanes and/or styrene block copolymers); tackifiers (such as, but not limited to, adhesion promoters); stabilizers (such as, but not limited to, anti-oxidants); and/or optional waxes.

In hot-melt formulations, polymers can determine the degree of flexibility, chemical inertness, and thermal stability of the formulations; tackifiers can determine/provide wetting, adhesion and bond strength of the formulations; antioxidants can provide/determine thermo-oxidative stability of the formulations when the formulations are in a liquid state; and waxes can help determine the formulation viscosity, softening point, as well as, open and set times of the formulations.

Open time refers to the time after an adhesive is applied to a substrate and before it fully cures or sets during which it can form a bond. Set time refers to the time from application of the formulation to solidification and the forming of the initial bond. Open times and set times for hot-melt formulations define the formulations processing parameters. Many factors affect open time of a hot-melt formulation including, but not limited to, the temperature at which it is applied, the substrate(s), the adhesive, additive(s), and/or amount of adhesive applied. Changing the wax used in the hot-melt formulation allows for the tuning of open and set times to a particular application. In some embodiments, waxes are chosen based on their compatibility with other components in the formulation.

Currently, waxes used in hot-melt adhesive formulations are mostly microcrystalline, paraffin, Fisher-Tropsch, alpha-olefin and/or polyolefin waxes.

In most embodiments, polypropylene based waxes have higher melt points than polyethylene, Fisher Tropsch and/or microcrystalline based waxes. In many embodiments, this high melting point is desirable. Hot-melt formulations utilizing polypropylene waxes also tend to have better bond strength and integrity at high-temperatures; adhere better to bond surfaces such as polypropylene, polypropylene copolymers, and/or lower surface energy materials such as polyvinylidene fluoride; and/or have higher resistance to various chemicals such as, but not limited to, acetic acid, 30% hydrogen peroxide and naphtha, compared to hot-melt formulations utilizing polyethylene waxes. However, polypropylene waxes, styrenic oligomers, and styrenic polymers are not common in hot-melt adhesives formulations due to, among other things, their lack of thermal stability over extended periods of time, and/or poor compatibility with polymer scaffold materials, which can lead to phase separation, poor adhesion, and/or bond failure.

Current attempts to prepare thermally-stable and homogeneous hot-melt adhesive formulations with polypropylene waxes have resulted in expensive and/or overly complex formulations. Current hot-melt formulations with polypropylene waxes, styrenic polymers, and/or styrenic oligomers often require additional steps such as grafting and/or need additional chemical reagents, compatibilizers and/or copolymers. In some instances, the formulations created have poor adhesion properties, require the use of hazardous materials such as maleic anhydride and maleates, and/or have high viscosities over 2000 cps when measured at 170° C.

What is needed are additives derived from polymeric material that are compatible with generic hot-melt formulations based on ethylene vinyl acetates, amorphous poly-alpha-olefins, thermoplastic polyolefins and/or similar copolymers without increasing the cost of hot-melt adhesive formulations.

### SUMMARY OF THE INVENTION

Shortcomings of conventional methods of producing hot-melt formulations utilizing polyethylene waxes, polypropylene waxes, styrenic polymers and/or styrenic oligomers waxes are overcome by a method for forming a depolymerized wax and employing the wax to the hot-melt formulations. The process comprises:
(a) selecting a solid polymeric material;
(b) heating the solid polymeric material in an extruder to produce a molten polymeric material;
(c) filtering the molten polymeric material;
(d) placing the molten polymeric material through a depolymerization process in a reactor to produce a depolymerized wax material;
(e) adding the depolymerized wax material to a hot-melt formulation. This addition can be done directly from the reactor in a liquid form, or at a later time through addition of solid depolymerized wax product.

The present method can be continuous or semi-continuous.

In the present method, the polymeric material can be polypropylene, polyethylene, polystyrene and/or mixture of the same. The polymeric material can contain recycled plastics.

In some embodiments, the depolymerization process employs a catalyst. In some embodiments, the catalyst employs a zeolite and/or alumina support.

A hot-melt formulation can utilize a wax wherein said wax is created via depolymerization of a polymer. In some embodiments, the polymer is polypropylene, polyethylene, and/or polystyrene. In some embodiments, the hot-melt formulation can include, among other things, ethylene-vinyl acetate copolymers, olefinic block copolymer, amorphous polyolefins, styrene block copolymers, amorphous poly-alpha-olefins, thermoplastic polyolefins, tackifiers, stabilizers, paraffin waxes and/or Fisher Tropsch waxes.

In some embodiments, the hot-melt formulation includes a depolymerized polymeric material. In some embodiments, the depolymerized polymeric material includes a polypropylene wax, a polyethylene wax, styrenic polymers and/or styrenic oligomers.

In some embodiments, the hot-melt formulation includes an ethylene-vinyl acetate copolymer; an olefinic block copolymer; an amorphous polyolefin; a styrene block copolymer; an amorphous poly-alpha-olefin; a thermoplastic polyolefin; a tackifier; a stabilizer; a paraffin wax; and/or a Fisher Tropsch wax.

In some embodiments, the tackifier is one of an aliphatic, an aromatic, a mixed aliphatic-aromatic, a cyclic, and/or rosin derivative.

In some embodiments, the stabilizer is an anti-oxidant.

In some embodiments, the stabilizer is between 1 percent by weight and 3 percent by weight of said hot-melt formulation.

In some embodiments, the stabilizer is efficient for temperatures up to 300° C.

In some embodiments, the tackifier is between 20 percent by weight and 50 percent by weight of the hot-melt formulation

In some embodiments, the polypropylene wax, polyethylene wax, styrenic polymers and/or styrenic oligomers are between 1 percent by weight and 20 percent by weight of said hot-melt formulation.

In some embodiments, the polypropylene wax is a maleated polypropylene wax or a succinated polypropylene wax.

In some embodiments, the polyethylene wax is an oxidized polyethylene wax.

In some embodiments, the styrenic polymer or styrenic oligomer is a maleated styrenic polymer, a maleated styrenic oligomer, a succinated styrenic polymer, or a succinated styrenic oligomer.

A method of creating a hot-melt formulation with a depolymerized polymeric material, said depolymerized polymeric material comprising a polypropylene wax, a polyethylene wax, styrenic oligomers, styrenic polymers.

### BRIEF DESCRIPTION OF THE DRAWINGS

FIG. 1A-FIG. 1C are a set of photographs showing three different hot-melt formulations.

FIG. 2 is a differential scanning calorimetry graph demonstrating the difference between a depolymerized polypropylene wax and two non-depolymerized polypropylene waxes.

FIG. 3 is schematic of creating a depolymerized polymeric product and utilizing it in a hot-melt formulation.

FIG. 4 is a Gel Permeation Chromatography Chromatogram comparing a conventional polypropylene wax with a depolymerized polypropylene wax.

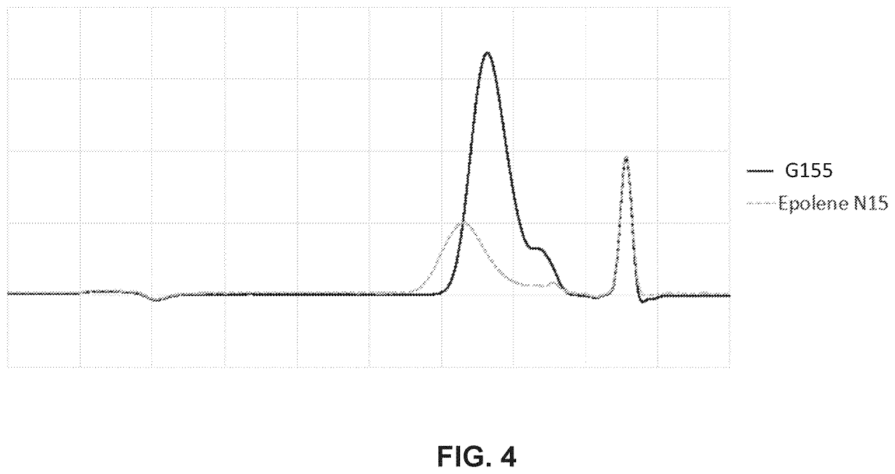

### DETAILED DESCRIPTION OF ILLUSTRATIVE EMBODIMENT(S)

A process of converting polymeric material, such as waste polymeric material, into wax is described below. The wax can then be employed with hot-melt formulations.

In some embodiments, the hot-melt formulation can comprise, among other things, polymers such as, but not limited to, ethylene-vinyl acetate copolymers, olefinic block copolymers, amorphous polyolefins and/or styrene block copolymers, amorphous poly-alpha-olefins, thermoplastic polyolefins, tackifiers, stabilizers, and/or polyethylene, paraffin, Fisher-Tropsch, polypropylene waxes, polyethylene waxes, and/or styrenic oligomers or polymers.

In some embodiments, the tackifiers are aliphatic, aromatic, mixed aliphatic-aromatic, cyclic, and/or rosin derivatives. In some embodiments, the stabilizers are anti-oxidants. In some embodiments, the polymeric material is manufactured by depolymerization of recycled plastic to create polypropylene wax(es), polyethylene wax(es), styrenic polymers and/or styrenic oligomers. In some embodiments the depolymerization process utilizes a catalyst such as [Fe—Cu—Mo—P]/Al₂O₃, Zeolite and/or alumina supported systems, and/or thermal depolymerization.

In some embodiments, the polymers of the hot-melt formulation are between an inclusive range of about 0.1 percent by weight to 50 percent by weight of the hot-melt formulation. In some preferred embodiments, the polymers of the hot-melt formulation are between an inclusive range of about 10 percent by weight to 40 percent by weight of the hot-melt formulation. In some more preferred embodiments, the polymers of the hot-melt formulations are between an inclusive range of about 15 percent by weight to 35 percent by weight of the hot-melt formulation. In some embodiments, the polymers include, ethylene vinyl acetates, amorphous poly-alpha-olefins, thermoplastic polyolefins and/or similar copolymers.

In some embodiments, the tackifying agents of the hot-melt formulation are between an inclusive range of about 0.1 percent by weight to 70 percent by weight of the hot-melt formulation. In some preferred embodiments, the tackifying agents of the hot-melt formulation are between an inclusive range of about 10 percent by weight to 60 percent by weight of the hot-melt formulation. In some more preferred embodiments, the tackifying agents of the hot-melt formulations are between an inclusive range of about 20 percent by weight to 50 percent by weight of the hot-melt formulation.

In some embodiments, the polyethylene waxes, polypropylene waxes, styrenic polymers and/or styrenic oligomers of the hot-melt formulation is between an inclusive range of about 0.01 percent by weight to 50 percent by weight of the hot-melt formulation. In some preferred embodiments, the polyethylene waxes, polypropylene waxes, styrenic polymers and/or styrenic oligomers of the hot-melt formulation is between an inclusive range of about 1 percent by weight to 30 percent by weight of the hot-melt formulation. In some more preferred embodiments, the polyethylene waxes, polypropylene waxes, styrenic polymers and/or styrenic oligomers of the hot-melt formulation is between an inclusive range of about 1% to 20% wt. % of the hot-melt formulation.

In some embodiments, the stabilizers are efficient for temperatures up to 300° C.

In some embodiments, the stabilizers of the hot-melt formulation are between an inclusive range of about 0.01 percent by weight to 10 percent by weight of the hot-melt formulation. In some preferred embodiments, the stabilizers of the hot-melt formulation are between an inclusive range of about 0.1 percent by weight to 5 percent by weight of the hot-melt formulation. In some more preferred embodiments, the stabilizers of the hot-melt formulation are between an inclusive range of about. 1 percent by weight to 3 percent by weight of the hot-melt formulation.

In some embodiments the hot-melt formulation is prepared by melting and stirring together copolymers, such as ethylene vinyl acetates, and polyethylene waxes, polypropylene waxes, styrenic polymers and/or styrenic oligomers under continuous heating that does not exceed the degradation temperatures of the ingredients. In some embodiments, the copolymers and polyethylene waxes, polypropylene waxes, styrenic polymers and/or styrenic oligomers are heated between an inclusive range of about 170° C. to 200° C. In some embodiments, tackifier and antioxidants are then mixed in. The resulting melted hot-melt adhesive formulations can be processed into various forms upon solidification.

In some embodiments, the polypropylene wax can be a chemically-functionalized polypropylene wax such as, but not limited to, maleated polypropylene wax or succinated polypropylene wax. In some embodiments, the polypropylene wax is created via a catalytic and/or thermal depolymerization process.

In some embodiments, maleated polypropylene wax, that is, polypropylene wax grafted with maleic anhydride, can have a viscosity between an inclusive range of about 100 cps-5,000 cps measured at 190° C. (as measured by ASTM D1986), a drop point between an inclusive range of about 150° C.-165° C. (as measured by ASTM D127), and an acid number between an inclusive range of about 10-70 g KOH/g (as measured by ASTM D1386).

In some embodiments the hot-melt formulation is prepared by melting and stirring together copolymers, such as ethylene vinyl acetates, and polyethylene waxes, polypropylene waxes, styrenic polymers and/or styrenic oligomers under continuous heating that does not exceed the degradation temperatures of the ingredients. In some embodiments, the copolymers and polyethylene waxes, polypropylene waxes, styrenic polymers and/or styrenic oligomers are heated between an inclusive range of about 170° C. to 200° C. In some embodiments, tackifier and antioxidants are then mixed in. The resulting melted hot-melt adhesive formulations can be processed into various forms upon solidification.

In some embodiments, the polyethylene wax can be an oxidized polyethylene wax. In some embodiments, the polyethylene wax is created via a catalytic and/or thermal depolymerization process.

In some embodiments the hot-melt formulation is prepared by melting and stirring together copolymers, such as ethylene vinyl acetates, and styrenic block copolymers under continuous heating that does not exceed the degradation temperatures of the ingredients. In some embodiments, the copolymers and styrenic block polymers/olymers are heated between an inclusive range of about 170° C. to 200° C. In some embodiments, tackifier and antioxidants are then mixed in. The resulting melted hot-melt adhesive formulations can be processed into various forms upon solidification.

In some embodiments, the styrenic polymers/oligomers can be chemically-functionalized styrenic polymers/oligomers such as, but not limited to, maleated styrenic polymers/oligomers or succinated styrenic polymers/oligomers. In some embodiments, the styrenic polymers/oligomers are created via a catalytic and/or thermal depolymerization process.

In some embodiments, the styrenic oligomers or polymers can have a viscosity between an inclusive range of about 3,000 cps-40,000 cps measured at 200° C. (as measured by ASTM D1986) and a glass transition temperature between an inclusive range of about 50° C.-85° C. (as measured by ASTM D7426).

In some embodiments, hot-melt adhesive formulations can be melted, stored, and/or transported in the liquid state at temperatures as high as 180° C. for several days.

The following examples were prepared to illustrate the benefits of hot-melt adhesive formulations based on polypropylene waxes obtained via depolymerization vs. hot-melt adhesive formulations based on polypropylene waxes obtained via non-depolymerization process and their use in conventional ethylene vinyl acetates hot-melt adhesive applications.

TABLE 1
Chemical List

| Type | Compound | Source |
|---|---|---|
| Fisher Tropsch Wax | SASOL ™ H1 | Sasol |
| Tackifying Agent | RE 100L | Kraton Corp. |
| (rosin ester) | | |
| Ethylene Vinyl | UL7710 | ExxonMobil Chemical |
| Acetates Polymer | | |
| Depolymerized | G155 | GreenMantra Technologies |
| Polypropylene Wax | | |
| Depolymerized | A155 | GreenMantra Technologies |
| Polypropylene Wax | | |
| Tackifying Agent | 8095 | Eastman Chemical Co. |
| (aromatic-modified | | |
| C5 resin) | | |
| Stabilizer | IRGANOX ™ 1010 | BASF |
| (anti-oxidant) | | |
| Polyethylene wax | CHU 561 | Trecora |
| Polypropylene wax | EPOLENE ™ N-15 | Westlake Chemical |
| Polypropylene wax | AC 1660 | Honeywell Additives |

TABLE 2
Composition of Hot-Melt Formulations

| | | Hot-Melt Formulation | | | | | |
|---|---|---|---|---|---|---|---|
| | | 1 | 2 | 3 | 4 | 5 | 6 |
| Compound | UL 7710 | 30% | 30% | 30% | 30% | 30% | 30% |
| | 8095 | 23.5% | 23.5% | 25% | 25% | 25% | 25% |
| | RE 100L | 22.5% | 22.5% | 24% | 24% | 24% | 24% |
| | IRGANOX ™ 1010 | 1% | 1% | 1% | 1% | 1% | 1% |
| | SASOL ™ H1 (FT Wax) | 13% | 0% | 15% | 0% | 0% | 15% |
| | CHU 561 | 0% | 13% | 0% | 15% | 15% | 0% |
| | G155 | 10% | 10% | 0% | 0% | 0% | 0% |
| | EPOLENE ™ N-15 | 0% | 0% | 0% | 0% | 0% | 5% |
| | AC1660 | 0% | 0% | 5% | 5% | 5% | 0% |

TABLE 3
Properties of Hot-Melt Formulations at ASTM Standards

| | Hot-Melt Formulation | | | | | |
|---|---|---|---|---|---|---|
| | 1 | 2 | 3 | 4 | 5 | 6 |
| Viscosity (cPs) | 700 | 625 | 762 | 639 | 799 | 802 |
| (ASTM D3236 - 15) | | | | | | |
| Softening point (° C.) | 145 | 148 | 145 | 122 | 97 | 131 |
| (ASTM E28 - 14) | | | | | | |
| Enthalpy (J/g), | 29.5 | 39 | 18.3 | 21 | 29.2 | 30.5 |
| (ASTM D3418) | | | | | | |
| Thermal Stability | Pass | Pass | Fail | Fail | Fail | Fail |
| (ASTM D4499) | | | | | | |

TABLE 4
Properties of Polypropylene waxes at ASTM Standards

Wax

| | G155 | N-15 | AC1660 |
|---|---|---|---|
| Dropping Point (° C.) | 155 | 161 | 150 |
| (ASTM D3964) | | | |
| Viscosity (cPs) | 75 | 600 | 60 |
| (ASTM D3236 - 15) | | | |
| Enthalpy (J/g), | 87 | 72 | 77 |
| (ASTM D3418)) | | | |
| Average Molecular Weight (Da) | 4,028 | 12,234 | 4,624 |
| (ASTM D6474 - 12) | | | |

In one experiment, polypropylene waxes derived from depolymerization were compared to formulations using polypropylene waxes derived from non-depolymerization methods. The ingredients of Formulation 1 through Formulation 6 of Table 2 were heated to 170° C. and stirred by an electric paddle mixer for 30 minutes to create Hot-melt Formulation 1, Hot-melt Formulation 2, Hot-melt Formulation 3, Hot-melt Formulation 4, Hot-melt Formulation 5, and Hot-melt Formulations 6. These formulations were poured into a form where they solidified.

Hot-melt Formulation 1, Hot-melt Formulation 2, Hot-melt Formulation 3, Hot-melt Formulation 4, Hot-melt Formulation 5, and Hot-melt Formulations 6 were tested for thermal stability according to ASTM D4499 (Standard Test Method for Heat Stability of Hot-Melt Adhesives). Hot-melt Formulation 1 and Hot-melt Formulation 2 showed good compatibility of the depolymerized waxes with the formulations (the resulting formulations appeared consistent with an absence of layers, segregation, gels, or agglomerates) per ASTM D4499. Formulation 3, formulation 4, formulation 5, and formulation 6, comprising lower percentages of external waxes, failed to generate stable formulations per ASTM D4499.

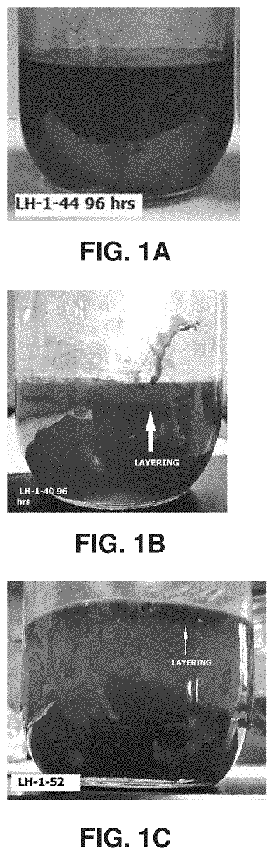

FIGS. 1A-1C are a set of photographs showing separation (layering, phasing out, aggregation, etc.) or lack thereof in three different formulations. FIG. 1A shows a hot-melt formulation with 10% G155 a depolymerized polypropylene wax (Formulation 1). FIG. 1B shows a hot-melt formulation with 5% EPOLENE™ N-15 (Formulation 6). FIG. 1C shows a hot-melt formulation with 5% AC 1660 (Formulation 3).

As illustrated in FIG. 1A-1C, the depolymerized polypropylene wax showed a high degree of compatibility and thermal stability with the hot-melt formulation at 10% (FIG. 1A). Meanwhile, both alternative polypropylene waxes produced via a non-depolymerization process, EPOLENE™ N-15 and AC-1660, at 5% loads were incompatible with the hot-melt formulation, failed to form thermally-stable hot-melt formulations, and showed signs of phasing out (separation in layers).

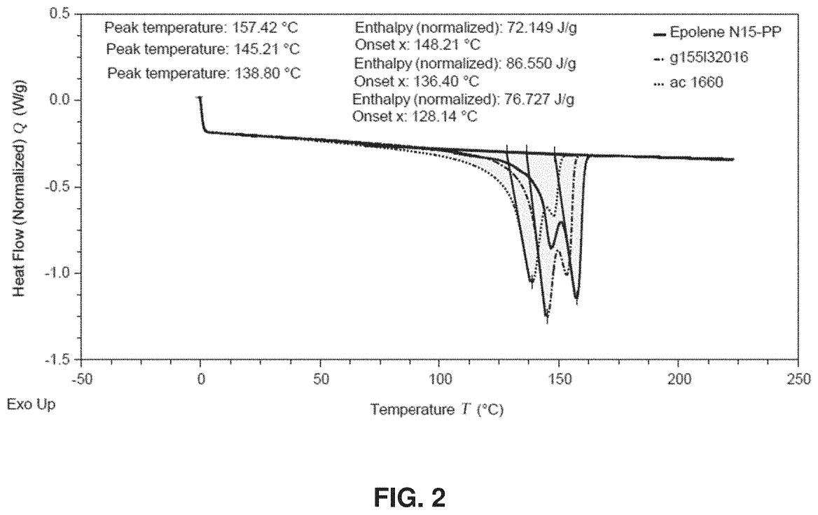

FIG. 2 is a differential scanning calorimetry (DSC) graph demonstrating the difference between a depolymerized polypropylene wax and commercially available non-depolymerized waxes including EPOLENE™ N-15, and HONEYWELL™ AC1660 wax. FIG. 2 demonstrates that the depolymerized wax G155 has both a unique melting transition and degree crystallinity (as per enthalpy value in W/g) compared to the non-depolymerized waxes AC-1660 and EPOLENE™ N-15.

Increased thermal stability of the depolymerized polypropylene wax hot-melt formulation is based on the more favorable molecular weight distribution, polydispersity index, and enthalpy when compared to formulations made using the industry standard EPOLENE™ N-15. The process for creating a depolymerized wax described creates a novel combination of a lower and more uniform molecular weight distribution, while maintaining a high softening point. This in turn creates a polypropylene wax designed with greater stability for hot-melt adhesive formulations. FIG. 2 shows that the depolymerized wax, G155, has relatively equal fractions of weight distributions occurring at two close peaks when compared to compared to N-15 and AC-1660, meaning the G155 wax has two relatively compatible polypropylene chains that can interact with hot-melt adhesives constituents when compared to the N-15 and AC-1660 samples that have chains in relatively unequal ratios. The use of waxes with less compatible polypropylene chains often results in more phase separation.

In addition to the relatively equal and compatible polypropylene chains, the G155 has lower molecular weights on average when compared to the N-15 and AC-1660. These lower molecular weights are known to disperse more evenly in formulations with other polymers and shorter molecules than chains with higher molecular weights. Polypropylene with long chains (which is common for traditionally used waxes) often require compatibilizers to prevent phasing out. The lower molecular weight distributions of the depolymerized polypropylene wax keep the hot-melt formulation consistent over time and prevent, or at least reduce, separation and/or phasing out.

The present method involves two main concepts: (1) the creation of polypropylene waxes, polyethylene waxes, styrenic polymers, and/or styrenic oligomers via depolymerization of plastics, and then (2) adding the polypropylene waxes, polyethylene waxes, styrenic polymers, and/or styrenic oligomers to hot-melt formulations.

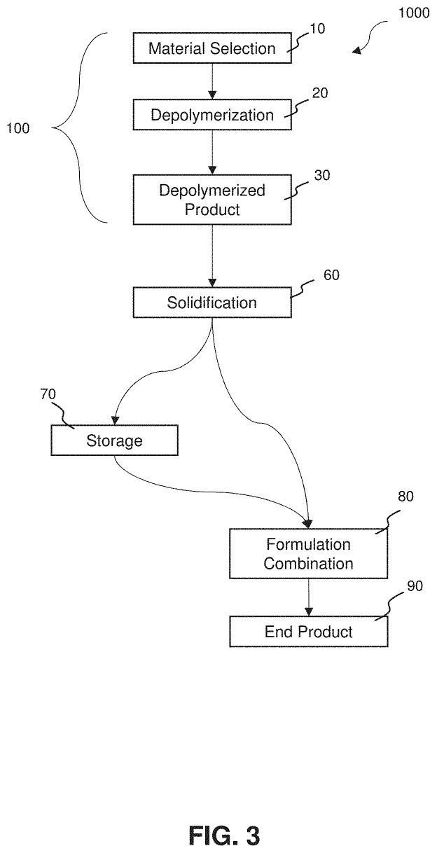

Turning to FIG. 3, Method 1000 is shown for creating a depolymerized polymeric product and combining it with a hot-melt formulation.

Section 100 of method 1000 involves the depolymerization of a feedstock to create a depolymerized product. In at least some embodiments, a feedstock is chosen at Material Selection Stage 10 and is depolymerized at Depolymerization Stage 20 to create a depolymerized product at Depolymerized Product Stage 30.

In some embodiments, the feedstock is a polymeric material. In some embodiments, the polymeric material is polypropylene (PP). In other embodiments, the polymeric material includes polypropylene. In some embodiments, lower levels of polystyrene, high density polyethylene (HDPE), low density polyethylene (LDPE), linear low-density polyethylene (LLDPE), and/or other variations of polyethylene including cross-linked polyethylene, polyethylene terephthalate (PET), ethylene-vinyl acetate, (polyvinyl chloride) PVC, (ethylene vinyl alcohol) EVOH, and undesirable additives and/or contaminants, such as fillers, dyes, metals, various organic and inorganic additives, moisture, food waste, dirt, and/or other contaminating particles can be present in the feedstock.

In some embodiments, the polymeric material is polyethylene. In some embodiments, the polymeric material is polypropylene. The polymeric material can be polypropylene (PP), high density polyethylene (HDPE), low density polyethylene (LDPE), linear low-density polyethylene (LLDPE), or other variations of polyethylene.

In some embodiments, the polymeric material includes both polyethylene and polypropylene material. In some embodiments, the polymeric material is divided evenly by weight between polyethylene and polypropylene. In some embodiments, the polymeric material can contain up to 20% PP, lower levels of polystyrene, polyethylene terephthalate (PET), ethylene-vinyl acetate (EVA), (polyvinyl chloride) PVC, (ethylene vinyl alcohol) EVOH, and undesirable additives and/or contaminants, such as fillers, dyes, metals, various organic and inorganic additives, moisture, food waste, dirt, or other contaminating particles.

In some embodiments, the polymeric material comprises recycled plastics. In some embodiments, the polymeric material comprises virgin plastics. In other or the same embodiments, the polymeric material comprises recycled plastics and/or virgin plastics.

In some embodiments, the polymeric material includes waste polymeric material feed. Suitable waste polymeric material feeds includes mixed polyethylene waste, mixed polypropylene waste, and/or a mixture of polyethylene and polypropylene waste. The mixed polyethylene waste can include LDPE, LLDPE, HDPE, PP, or a mixture including combinations of LDPE, LLDPE, HDPE, and PP. In some embodiments, the mixed polyethylene and/or polypropylene waste can include film bags, milk jugs, pouches, lids, totes, pails, caps, agricultural film, and/or packaging material. In some embodiments, the waste polymeric material feed includes up to 10% of material that is other than polymeric material, based on the total weight of the waste polymeric material feed.

In some embodiments, the polymeric material is one of virgin, post-consumer, and/or post-industrial polypropylene (exemplary sources including film, caps, lids, bags, jugs, bottles, pails, and/or other items containing primarily polypropylene).

In some embodiments, the polymeric material is polystyrene. In certain embodiments, the polystyrene is a recycled polystyrene. In some embodiments, the recycled polystyrene is a pellet made from recycled polystyrene foam and/or rigid polystyrene. Suitable waste polystyrene material includes, but is not limited to, mixed polystyrene waste such as expanded, and/or extruded polystyrene foam, and/or rigid products. For example, foam food containers, or packaging products. The mixed polystyrene waste can include various melt flows and molecular weights. In some embodiments, the waste polystyrene material feed includes up to 25% of material that is other than polystyrene material, based on the total weight of the waste polystyrene material feed.

In some embodiments, virgin polystyrene can also be used as a feedstock.

In some embodiments, the polymeric feed material is one of, or a combination of, virgin polystyrene and/or any one of, or combinations of post-industrial and/or post-consumer waste polystyrene.

In some embodiments, the polystyrene feed has an average molecular weight between, and inclusive of, 150,000-500,000 amu. In some embodiments, the polystyrene feed has an average molecular weight between, and inclusive of, 200,000-300,000 amu.

In some embodiments, polystyrene feed is sorted/selected and/or prepared for treatment. In some embodiments, the feed can contain up to 25% polyolefins (PP, PE), PET, EVA, EVOH, and lower levels of undesirable additives or polymers, such as nylon, rubber, PVC, ash, filler, pigments, stabilizers, grit and/or other unknown particles.

In some embodiments, the depolymerized product is made by catalytic depolymerization of the polymeric material during Depolymerization Stage 20. In some embodiments, the depolymerized product is made by thermally degrading the polymeric material during Depolymerization Stage 20. In some embodiments, the Depolymerization Stage 20 involves both thermal and catalytic depolymerization.

In some embodiments the depolymerization process utilizes a catalyst such as [Fe—Cu—Mo—P]/Al₂O₃, Zeolite and/or alumina supported systems, and/or thermal depolymerization. In some embodiments, the catalyst can be contained in a permeable container.

In some embodiments, the depolymerized product is a wax. In some embodiments, the depolymerized product is a styrenic polymer/oligomer.

Due to the nature of depolymerization, the depolymerized product(s) can be created with a wide spectrum of hardness and melting points. This allows for the creation of formulation-specific depolymerized products.

In some embodiments, depolymerized products can be chemically and functionally modified by grafting monomers or copolymers such as, but not limited to, maleic anhydride or succinate.

In at least some embodiments, depolymerized polypropylene wax, polyethylene wax, styrenic polymers, or styrenic oligomers additives are mixed in-line with the balance of a hot-melt adhesive formulation. Some advantages of using depolymerization products in-line is a decrease in cost and reduction in the amount of energy used.

In some embodiments, the depolymerized polyethylene waxes, polypropylene waxes, styrenic polymers and/or styrenic oligomers are transferred into optional pelletizing or product forming equipment at Solidification Stage 60. In at least some embodiments, the pellets or prills of depolymerized polyethylene waxes, polypropylene waxes, styrenic polymers and/or styrenic oligomers are between an inclusive range of about 1 mm to 10 mm in size. In some preferred embodiments, the pellets are between an inclusive range of about 1 mm to 3 mm in size.

In some embodiments, the depolymerized product can be stored in Storage Stage 70 or directly mixed into various formulations at Formulation Stage 80. A product is created at End Product Stage 90. In some embodiments, the product created at End Product Stage 90 can be further modified. In some embodiments, the end product is a hot-melt formulations such as, but not limited to, an adhesive, sealant, or coating.

Depolymerization products can be chosen to match specific viscosity, hardness, melting temperature, and/or dropping point ranges required by given applications.

The above method can employ a variety of depolymerized products, including those with melt points between an inclusive range of about 140° C. to 175° C., and viscosities between an inclusive range of about 10 cps to 2000 cps measured at 190° C. In some preferred embodiments, the depolymerized products employed have melting points between an inclusive range of about 145° C. to 165° C. In some preferred embodiments, the depolymerized products employed have a viscosity between an inclusive range of about 10 cps to 500 cps measure at 190° C.

In some embodiments, such as those utilizing polyethylene waxes, the depolymerized products include those having melting points between an inclusive range of 100° C. to 140° C. and viscosities between an inclusive range of 10 cps to 5000 cps.

In some embodiments, the depolymerized product comprises styrenic polymer and/or styrenic oligomers having viscosities between an inclusive range of 5,000 cps-20,000 cps at 200° C.

The following conclusions can be drawn from the foregoing test results:
hot-melt formulations utilizing polypropylene wax created via depolymerization can be thermally-stable;
hot-melt formulations utilizing polypropylene wax created via depolymerization can have viscosities equal to or lower than typical industry values;
hot-melt formulations utilizing polypropylene wax created via depolymerization are relatively easy and/or cost effective to prepare compared to hot-melt formulations utilizing traditional polypropylene waxes;
polyethylene waxes, polypropylene waxes, styrenic polymers and/or styrenic oligomers derived via a depolymerization process can be used in higher percentages of hot-melt formulations utilizing ethylene vinyl acetates compared to traditional polypropylene waxes, allowing for greater modifications of open time, viscosity, set time, and/or thermal stability of a hot-melt formulations;
polyethylene waxes allow for changes in set time, open time, viscosity and flowability of hot-melt adhesives.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A hot-melt formulation comprising:
(a) a depolymerized polymeric material, wherein said depolymerized polymeric material comprises a polypropylene wax.

2. The hot-melt formulation of claim 1 further comprising:
(b) an ethylene-vinyl acetate copolymer.

3. The hot-melt formulation of claim 1 further comprising:
(b) an olefinic block copolymers.

4. The hot-melt formulation of claim 1 further comprising:
(b) an amorphous polyolefin.

5. The hot-melt formulation of claim 1 further comprising:
(b) a styrene block copolymer.

6. The hot-melt formulation of claim 1 further comprising:
(b) an amorphous poly-alpha-olefin.

7. The hot-melt formulation of claim 1 further comprising:
(b) a thermoplastic polyolefin.

8. The hot-melt formulation of claim 1 further comprising:
(b) a tackifier.

9. The hot-melt formulation of claim 1 further comprising:
(b) a stabilizer.

10. The hot-melt formulation of claim 1 further comprising:
(b) paraffin wax.

11. The hot-melt formulation of claim 1 further comprising:
(b) Fisher Tropsch wax.

12. The hot-melt formulation of claim 8 herein said tackifier is one of an aliphatic, an aromatic, a mixed aliphatic-aromatic, a cyclic, and/or rosin derivative.

13. The hot-melt formulation of claim 9 wherein said stabilizer is an anti-oxidant.

14. The hot-melt formulation of claim 8 wherein said tackifier is between 20 percent by weight and 50 percent by weight of said hot-melt formulation.

15. The hot-melt formulation of claim 1 wherein said depolymerized polypropylene wax is between 1 percent by weight and 20 percent by weight of said hot-melt formulation.

16. The hot-melt formulation of claim 9 wherein said stabilizer is efficient for temperatures up to 300° C.

17. The hot-melt formulation of claim 1 wherein said polypropylene wax is a maleated polypropylene wax or a succinated polypropylene wax.

18. A hot-melt formulation comprising:
(a) a depolymerized polymeric material, wherein said depolymerized polymeric material comprises a polyethylene wax.

19. The hot-melt formulation of claim 18 wherein said depolymerized polyethylene wax is an oxidized polyethylene wax.

20. The hot-melt formulation of claim 18 wherein said depolymerized polyethylene wax is between 1 percent by weight and 20 percent by weight of said hot-melt formulation.
